(19) United States
(12) Patent Application Publication
(10) Pub. No.: US 2008/0243714 A1
(43) Pub. Date: Oct. 2, 2008

(54) Methods and System for Determining Investment Performance Compensation

(76) Inventor: John Hassett, Marblehead, MA (US)

Correspondence Address: Brian M. Dingman;Mirick, O'Connell, DeMallie & Lougee, LLP, 1700 West Park Drive, Westborough, MA, 01581, US

(21) Appl. No.: 11/861,384

(22) Filed: Sep. 26, 2007

Related U.S. Application Data
(60) Provisional application No. 60/908,642, filed on Mar. 28, 2007.

(51) Int. Cl. G06Q 40/00

(52) U.S. Cl. 705/36 R

(57) ABSTRACT

Methods and systems for determining compensation to an investment manager for the financial performance of an investment portfolio consisting of at least one investment. A benchmark measure of investment performance is selected. The portfolio's gain or loss over a time period, as measured by the Alpha or the simple performance of the investment portfolio against the benchmark, is determined. The amount of a predetermined return characteristic achieved in the portfolio over the time period is determined. A relationship between the amount of the predetermined return characteristic and the compensation, based on the Alpha or simple performance, is established. This relationship is then used to determine the compensation for the time period.

### CROSS-REFERENCE TO RELATED APPLICATION

This application claims priority of Provisional application Ser. No. 60/908,642, filed on Mar. 28, 2007, the entire contents of which are incorporated herein by reference.

### FIELD OF THE INVENTION

The present invention relates to the calculation of the compensation to investment managers for their services.

### BACKGROUND OF THE INVENTION

Compensation to investment managers for their services has historically been based on various formulas that: (i) reward baseline efforts typically in the form of a “Management Fee” consisting of a small percentage of the assets that are being managed, and in some cases also (ii) reward investment performance in the form of profit sharing between the investor and the investment manager. The present invention addresses the latter, otherwise know as “Incentive Fees”.

In the vast majority of cases, compensation for investment performance by an investment manager is directly related to the absolute return on the invested assets, such that the profits generated are shared between the investor and the investment manager. These Incentive Fees are normally fixed at a specific percentage of profit, typically ranging from a fixed 5% of profits over a given period (usually a year) to over 20% in such period.

So called “traditional ” investment management—typically represented by the purchase and ultimate sale of shares in publicly traded securities—are generally rewarded only through Management Fees, as the objective of such traditional investment is the simple out-performance of the derived investment portfolio over a pre-determined benchmark such as the S&P 500. This compensation method results in fees paid to the investment manager, regardless of return or performance; the only penalty for poor performance by an investment manager in this case occurs through the loss of the investors' business. Incentive Fees were developed as a means of rewarding investment managers for “Absolute Return”, that is a return on investment discrete from a benchmark, or more specifically, rewarding any and all profit above zero profit. This method of compensation was designed to incent a focus on profit in all market conditions and usually provides a “penalty period” when losses occur, such that the losses must be recovered before the incentive fee is reinstituted. Incentive fees may incorporate a minimum return for the investor before profit sharing is provided to the investment manager. For example, the investment manager may receive no share of profits until an 8% cumulative return has been received by the investor, and then receives 20% of profits above this 8% baseline profit. These may accumulate year-to-year, so that the manager receives 20% of total profits that exceed 8% per year, over the lifetime of the investment.

Incentive fee structures may also incorporate a “penalty” for losses, such that all losses must first be recovered before profit sharing is provided again after a loss. In this case, the Incentive Fee is taken on the excess return over the highest value of the investment in the previous periods. For example, the manager might be paid 20% of profits that increase the total investment value from the previous period; typically measured year-over-year. If a fund begins with $100 million, and at the end of one year is worth $106 million, the manager receives 20% of the $6 million profit. If at the end of year 2 the fund is worth less than $106 million, the manager receives nothing. If at the end of year 3 the fund is worth $108 million, the manager receives 20% of the $2 million increase from the previous highest value of $106 million.

As investors become more sophisticated, and more demanding of the investment manager community, new Incentive Fee structures and formulas have begun to emerge, rewarding alternative types of return, for instance. One such alternative type of return is a hybrid of traditional benchmarked return and Absolute Return, incorporating the measurement of “Alpha” return, which is return in excess of a benchmark's return, after consideration of Beta. Under a so called “Alpha Fee” formula, the investment manager is paid an incentive fee for the production of Alpha, that is, he or she is paid an incentive fee on only on that portion of the return derived distinct from that provided by a pre-designated benchmark.

“Regression Alpha” is a return characteristic that is often used to represent the excess return generated by a manager's skill, and is typically calculated using linear regression. Periodic (e.g., monthly) portfolio returns are plotted on the y axis against benchmark returns (e.g., the S&P 500) on the x axis. A line is fitted to these points by linear regression using the least-squares method, which finds the line that minimizes the sum of the squares of the distances between the line and the data points. The point at which this line crosses the y axis is the Alpha for that time period, and represents the average monthly statistical value-add of the portfolio compared to the benchmark. The slope of the fitted line is the Beta. See the example shown in FIG. 1, which maps hypothetical returns against benchmark returns for the twelve previous months. In this case the Alpha (the y-intercept) is 0.0024 (or 0.24%), and the Beta (the slope) is −0.7616. For the purpose of comparison to annual returns, the average monthly Alpha is annualized by compounding the average for twelve months as: ((1+Alpha)̂12)−1. For this case, in which Alpha is 0.0024, this annualized regression Alpha is 0.29%.

“Simple Alpha” is a proxy for Alpha, determined by subtracting the benchmark return over the period of interest from the portfolio return over the same period. In the case of a short portfolio, the additive inverse of the benchmark return is subtracted from the portfolio return.

“Alpha Fees” are an incentive for the production of Alpha. Alpha Fees are calculated by multiplying Alpha by a percentage incentive fee. This rewards return as with all well-established Incentive Fee formulas, but only return in excess of that provided by the market or another pre-designated benchmark. This may provide Incentive Fee payments to the investment manager, in some cases, where there is no Absolute Return on the investment, but conversely does not pay a fee on that portion of positive returns generated by the market or the predetermined benchmark.

There are also many well-defined “return characteristics” that are measured by investors as a means of understanding and categorizing an investment portfolio, to determine if such portfolio is appropriate for the investor. Some of the most commonly used return characteristics are: risk as measured by return deviation from the norm, known as “Standard Deviation”; risk as measured by the deviation between the market's or a benchmark's return and the return derived from an investment manager's portfolio return, known as “Beta; the relationship between an investment manager's portfolio return, after adjustment for risk, and the return of the market, this measure being known as the “Sharpe Ratio”; and of course “Correlation”. Other, less frequently used return characteristics include: “Sortino Ratio”, “R-Squared”, “Up-Side Capture” and “Down-Side Capture”, among a variety of others. One newer return characteristic is the “Tuckerbrook Ratio”, which is defined as the “Downside Capture Ratio” divided by the “Upside Capture Ratio”. The Downside Capture Ratio is the portfolio return divided by the benchmark return for months in the period being analyzed (typically one year) that the benchmark was down, while the Upside Capture Ratio is that same ratio for the months in the same period that the benchmark was up. The Tuckerbrook Ratio is thus a measure of the performance of the manager relative to up and down markets.

Heretofore return characteristics have not been used for the calculation of incentive fees.

### SUMMARY OF THE INVENTION

The present invention provides systems and methods for compensating investment managers for investment performance discrete from absolute return, while providing incentives and rewarding predetermined investment return characteristics as they relate to Alpha and/or simple out-performance relative to a predetermined benchmark.

This invention features a method for determining compensation to an investment manager for the financial performance of an investment portfolio consisting of at least one investment, comprising selecting a benchmark measure of investment performance, determining the portfolio's gain or loss over a time period, as measured by the Alpha or the simple performance of the investment portfolio against the benchmark, determining the amount of a predetermined return characteristic achieved in the portfolio over the time period, establishing a relationship between the amount of the predetermined return characteristic and the compensation, based on the Alpha or simple performance, and using the relationship to determine the compensation for the time period.

The method may further comprise paying the determined compensation to the investment manager. The portfolio's gain or loss may be determined on a regression basis. The simple performance may comprise absolute return over zero return. The simple performance may comprise any pre-determined return measurement. The predetermined return characteristic may be determined before the portfolio's gain is determined.

Determining the amount of a predetermined return characteristic achieved in the portfolio may comprise determining the ratio between down-side capture and up-side capture. The portfolio's gain or loss in this case may be measured by simple Alpha. The predetermined return characteristic may comprise the Beta in the portfolio. The portfolio's gain or loss in this case may be measured by Regression Alpha. The predetermined return characteristic may comprise Correlation or the Sharpe Ratio in the portfolio.

The relationship may comprise a linear scale. Using the relationship may comprise mapping the determined amount of the predetermined return characteristic to the linear scale. Establishing a relationship between the amount of the predetermined return characteristic and the compensation, based on the Alpha or simple performance, may comprise determining compensation as a percentage of Alpha or simple performance.

The invention also features a computer-implemented data processing method for determining compensation to an investment manager for the investment performance of an investment portfolio consisting of at least one investment, the method comprising selecting a benchmark measure of investment performance, calculating the portfolio's gain or loss over a time period, as measured by the Alpha or the simple performance of the investment portfolio against the benchmark, calculating the amount of a predetermined return characteristic achieved in the portfolio over the time period, establishing a relationship between the amount of the predetermined return characteristic and the compensation, based on the Alpha or simple performance, and using the relationship to calculate the compensation for the time period.

The invention further features a system for determining compensation to an investment manager for the investment performance of an investment portfolio consisting of at least one investment relative to a predetermined benchmark measure of investment performance, comprising a database storing data representative of the investment portfolio, and a processing unit in communication with the database, the processing unit operative to calculate the portfolio's gain or loss over a time period, as measured by the Alpha or the simple performance of the investment portfolio against the benchmark, calculate the amount of a predetermined return characteristic achieved in the portfolio over the time period, establish a relationship between the amount of the predetermined return characteristic and the compensation, based on the Alpha or simple performance, and use the relationship to calculate the compensation for the time period.

### BRIEF DESCRIPTION OF THE DRAWINGS

Other objects, features and advantages will occur to those skilled in the art from the following description of the preferred embodiments, and the accompanying drawings, in which:

FIG. 1 is graph that illustrates the prior-art concepts of Regression Alpha and Beta calculations for a hypothetical investment portfolio over a one-year time period;

FIG. 2 is graph that illustrates a first embodiment of a method of determining investment portfolio manager Incentive Fee compensation in accordance with the invention; and

FIG. 3 is graph that illustrates a second embodiment of a method of determining investment portfolio manager Incentive Fee compensation in accordance with the invention.

### DESCRIPTION OF THE PREFERRED EMBODIMENTS OF THE INVENTION

The invention comprises methods and systems for determining investment portfolio manager compensation with formula(s) for Incentive Fee compensation discrete from absolute return. The invention provides a means to target and reward specific return characteristics on a sliding scale related to Alpha. Under the formulas of the invention, Incentive Fees are calculated on a regression-basis, with meaningful periodicity (typically over the course of a year).

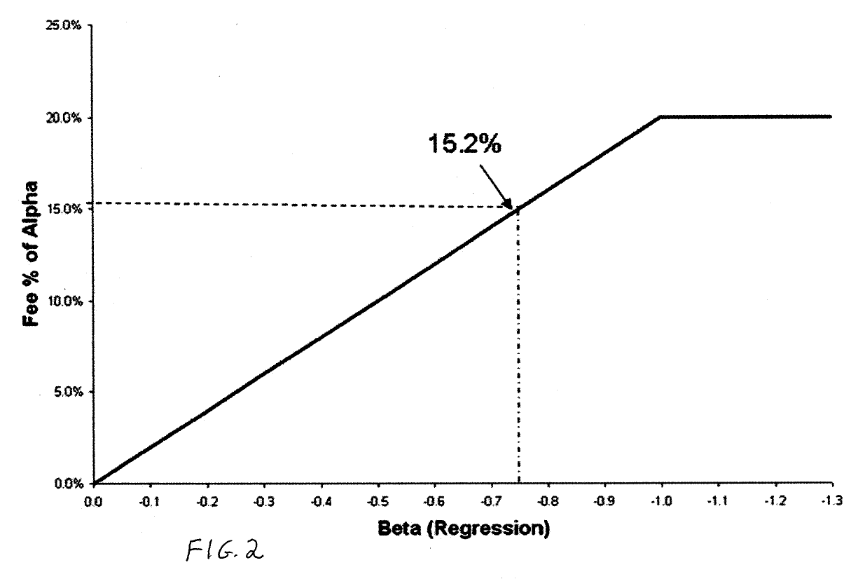

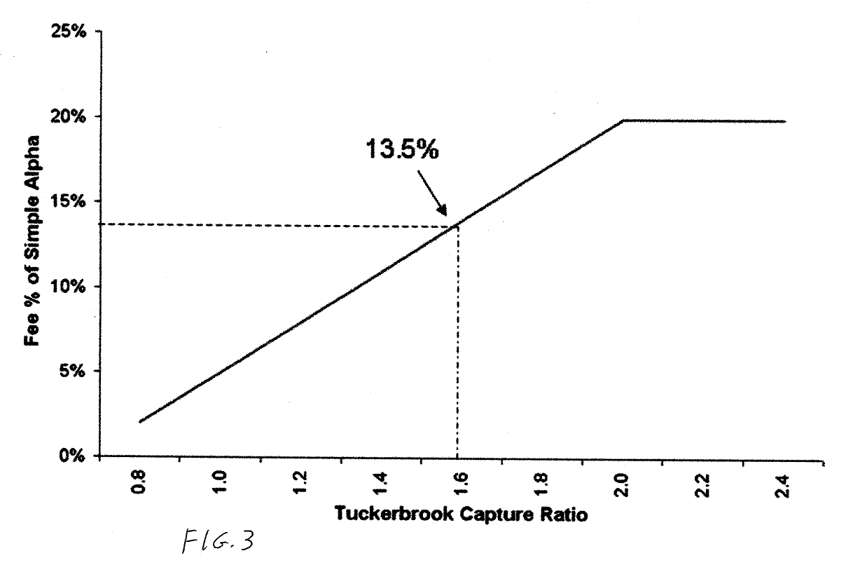

The invention involves first calculating either Alpha against the market or a different pre-determined benchmark, or calculating simple performance against the market or a different pre-determined benchmark. This is termed herein the “First Calculation”. Then, a return characteristic or characteristics, such as Beta and/or the Tuckerbrook Ratio, is calculated on a regression-basis. This is termed herein the “Second Calculation.” Examples of such desired return characteristics include, but are not limited to: Standard Deviation, Beta, Regression Beta, Simple Alpha, Regression Alpha, Sharpe Ratio, Correlation, Tuckerbrook Capture Ratio, Sortino Ratio, R-Squared, Up-Side Capture, and Down-Side Capture. A relationship between the subject desired return characteristic and the variable determined by the First Calculation is determined a priori. Two examples of such are shown in FIGS. 2 and 3, which detail graph lines that are non-limiting examples of such relationships: Regression Beta vs. percentage of Regression Alpha (FIG. 2) and Tuckerbrook Capture Ratio vs. percentage of Simple Alpha (FIG. 3).

The result of the Second Calculation, which is the amount of such desired return characteristic achieved over the regression period, is then mapped into a pre-determined sliding scale (such as the examples shown in FIGS. 2 and 3). The scales provide an Incentive Fee that is a percentage of the variable determined by the First Calculation, for example either Regression Alpha or simple out-performance (Simple Alpha), from zero percent to 100 percent, or any amount there between. The resulting percentage is the percentage of the First Calculation that is paid to the portfolio manager as the Incentive Fee for the subject period. In the examples shown in FIGS. 2 and 3, this rewards the achieved Alpha or simple out-performance, respectively.

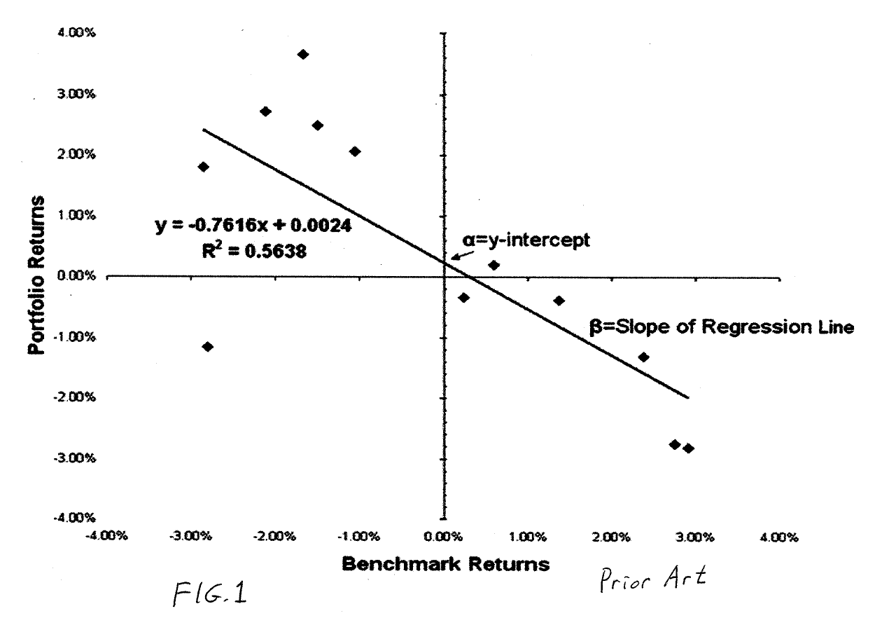

For example, FIG. 2 shows a hypothetical example of the use of a sliding scale according to the invention to determine an investment manager's fee. Alpha and Beta are first calculated (by regression) for the relevant period (e.g., the past year, as shown in FIG. 1). The “sliding scale” is a graph line that establishes a relationship between Beta and the percentage of Alpha that is paid as a management fee; in this case, the Incentive Fee as a percentage of Alpha increases as the absolute value of Beta increases. The slope of the scale line is set according to custom or contract, or perhaps by negotiation between an investor and a manager. To determine the fee, the Beta is mapped to the fee percentage of Alpha using the sliding scale. In the example shown in the drawing, the mathematical formula for the scale is: 20% (|Beta|). Accordingly, a Beta of −0.7616 corresponds to a fee percentage of 15.2%, meaning that the manager is paid 15.2% of the Alpha for the relevant time period. Thus, as the Beta changes, the Incentive Fee percentage also changes.

FIG. 3 shows another example of the use of a sliding scale according to the invention, in which the Tuckerbrook Ratio is the return characteristic used as the input, and the fee is a percentage of Simple Alpha. The mathematical formula for the scale is: 5%+15% (Tuckerbrook Ratio—1). According to this scale, a Tuckerbrook Ratio of 1.56 maps to a fee percentage of 13.5% of Simple Alpha.

Once the fee is determined in this manner, it is paid to the portfolio manager, who may be a person or group of people, or may be an institution such as a hedge fund.

The invention also may be accomplished in a system, and/or a computer-implemented data processing method, for determining compensation to an investment manager for the investment performance of an investment portfolio consisting of at least one investment. The system and the data processing method are preferably accomplished on a general-purpose computer with a processor and memory. As such general-purpose computers are well-known in the filed, such is not shown in the drawings. The computer has in its memory a database that includes data representative of the investment portfolio. The computer runs software that accomplishes the necessary calculations. The software can be resident on the computer, or can be resident in a remote computer, for example as an application that is accessible by the computer over the Internet, or a different network.

Although specific features of the invention are shown in some drawings and not others, this is not a limitation of the invention, as the various features can be combined differently to accomplish the invention. Other embodiments will occur to those skilled in the art and are within the following claims.

What is claimed is:

1. A method for determining compensation to an investment manager for the financial performance of an investment portfolio consisting of at least one investment, comprising:
selecting a benchmark measure of investment performance;
determining the portfolio's gain or loss over a time period, as measured by the Alpha or the simple performance of the investment portfolio against the benchmark;
determining the amount of a predetermined return characteristic achieved in the portfolio over the time period;
establishing a relationship between the amount of the predetermined return characteristic and the compensation, based on the Alpha or simple performance; and
using the relationship to determine the compensation for the time period.

2. The method of claim 1, further comprising paying the determined compensation to the investment manager.

3. The method of claim 1 in which the portfolio's gain or loss is determined on a regression basis.

4. The method of claim 1 in which the simple performance comprises absolute return over zero return.

5. The method of claim 1 in which the simple performance comprises any pre-determined return measurement.

6. The method of claim 1 in which the predetermined return characteristic is determined before the portfolio's gain is determined.

7. The method of claim 1 in which determining the amount of a predetermined return characteristic achieved in the portfolio comprises determining the ratio between down-side capture and up-side capture.

8. The method of claim 7 in which the portfolio's gain or loss is measured by simple Alpha.

9. The method of claim 1 in which the predetermined return characteristic comprises the Beta in the portfolio.

10. The method of claim 9 in which the portfolio's gain or loss is measured by Regression Alpha.

11. The method of claim 1 in which the predetermined return characteristic comprises Correlation in the portfolio.

12. The method of claim 1 in which the predetermined return characteristic comprises the Sharpe Ratio in the portfolio.

13. The method of claim 1 in which the relationship comprises a linear scale.

14. The method of claim 13 in which using the relationship comprises mapping the determined amount of the predetermined return characteristic to the linear scale.

15. The method of claim 1 in which establishing a relationship between the amount of the predetermined return characteristic and the compensation, based on the Alpha or simple performance, comprises determining compensation as a percentage of Alpha or simple performance.

16. A computer-implemented data processing method for determining compensation to an investment manager for the investment performance of an investment portfolio consisting of at least one investment, the method comprising:
selecting a benchmark measure of investment performance;
calculating the portfolio's gain or loss over a time period, as measured by the Alpha or the simple performance of the investment portfolio against the benchmark;
calculating the amount of a predetermined return characteristic achieved in the portfolio over the time period;
establishing a relationship between the amount of the predetermined return characteristic and the compensation, based on the Alpha or simple performance; and
using the relationship to calculate the compensation for the time period.

17. A system for determining compensation to an investment manager for the investment performance of an investment portfolio consisting of at least one investment relative to a predetermined benchmark measure of investment performance, comprising:
a database storing data representative of the investment portfolio; and
a processing unit in communication with the database, the processing unit operative to:
calculate the portfolio's gain or loss over a time period, as measured by the Alpha or the simple performance of the investment portfolio against the benchmark;
calculate the amount of a predetermined return characteristic achieved in the portfolio over the time period;
establish a relationship between the amount of the predetermined return characteristic and the compensation, based on the Alpha or simple performance; and
use the relationship to calculate the compensation for the time period.
